(19) United States
(12) Patent Application Publication
(10) Pub. No.: US 2009/0307115 A1
(43) Pub. Date: Dec. 10, 2009

(54) FACILITATING PROCUREMENT FUNCTIONS OVER A COMPUTER NETWORK

(75) Inventors: James J. Espejo, Poughkeepsie, NY (US); Raymond C. Harris, JR., Poughkeepsie, NY (US); Thomas J. Knight, Hopewell Junction, NY (US); Nancy Rousseau, Markham (CA); Lee Edward Towsley, Hopewell Junction, NY (US); Terell Raynard White, Cairo, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/543,526

(22) Filed: Aug. 19, 2009

Related U.S. Application Data
(62) Division of application No. 10/316,681, filed on Dec. 10, 2002.

(51) Int. Cl. G06Q 10/00; G06Q 30/00

(52) U.S. Cl. 705/30

(57) ABSTRACT

A method for facilitating procurement functions includes receiving an invoice at a centralized procurement location, retrieving a purchase order associated with the invoice, comparing price terms on the invoice to price terms on the purchase order, and comparing quantity terms on the invoice to quantity terms on the purchase order. If the price terms on the invoice and the quantity terms on the invoice match the price terms on the purchase order and the quantity terms on the purchase order, the method includes transferring the invoice to an accounts payable representative for payment. If either of the price terms on the invoice and the quantity terms on the invoice does not match either of the price terms on the purchase order and the quantity terms on the purchase order, the method includes initiating a blocked invoice referral. A storage medium for facilitating procurement functions is also provided.

### CROSS-REFERENCE TO RELATED APPLICATIONS

This application is a divisional of U.S. patent application Ser. No. 10/316,681, filed Dec. 10, 2002, the disclosure of which is incorporated by reference herein in its entirety.

### BACKGROUND

This invention relates generally to procurement activities, and more particularly, the present invention relates facilitating procurement functions over a computer network.

Electronic procurement relates to the business-to-business purchase and sale of goods and services over an electronic network. Electronic procurement activities are becoming increasingly mainstreamed into modern day business practices in an effort to automate and better control inventories, overhead costs, and improve manufacturing processes. The primary goal of any procurement system is to find the best products at the right prices. Product availability, supplier responsiveness and quality of service are also important considerations. Thus, for most businesses, the ability to integrate procurement tools with an optimal sourcing strategy for evaluating suppliers and managing purchasing contracts is a growing challenge.

Off-the-shelf commercial software products specialize in limited sourcing or procurement capabilities and are not fully integratable with existing enterprise applications. Existing processes require a high level of resources to support the distributed nature of these procurement and sourcing functions. This is particularly true for large businesses with widely scattered and remote facilities.

What is needed, therefore, is a consolidated system and process for handling procurement and sourcing functions that can accommodate large and complex enterprises.

### SUMMARY

Exemplary embodiments of the invention relate to facilitating procurement functions over a computer network. A method includes receiving an invoice at a centralized procurement location, retrieving a purchase order associated with the invoice, comparing price terms on the invoice to price terms on the purchase order, and comparing quantity terms on the invoice to quantity terms on the purchase order. If the price terms on the invoice and the quantity terms on the invoice match the price terms on the purchase order and the quantity terms on the purchase order, the method includes transferring the invoice to an accounts payable representative for payment. If either of the price terms on the invoice and the quantity terms on the invoice does not match either of the price terms on the purchase order and the quantity terms on the purchase order, the method includes initiating a blocked invoice referral.

The exemplary storage medium is embodied with computer readable instructions, which when executed by a computer, cause the computer to implement a method. The method includes receiving an invoice at a centralized procurement location, retrieving a purchase order associated with the invoice, comparing price terms on the invoice to price terms on the purchase order, and comparing quantity terms on the invoice to quantity terms on the purchase order. If the price terms on the invoice and the quantity terms on the invoice match the price terms on the purchase order and the quantity terms on the purchase order, the method includes transferring the invoice to an accounts payable representative for payment. If either of the price terms on the invoice and the quantity terms on the invoice does not match either of the price terms on the purchase order and the quantity terms on the purchase order, the method includes initiating a blocked invoice referral.

### BRIEF DESCRIPTION OF THE SEVERAL VIEWS OF THE DRAWINGS

Referring now to the drawings wherein like elements are numbered alike in the several FIGURES:

FIG. 1 is a block diagram of a system for implementing the tool in an exemplary embodiment;

FIG. 2 is a flowchart illustrating the purchase order process implemented via the tool in an exemplary embodiment;

FIG. 3 is a flowchart illustrating the “blocked invoice” process implemented via the tool in an exemplary embodiment;

FIG. 4 is a sample aged invoice document as seen by an invoice specialist in an exemplary embodiment of the invention; and

FIG. 5 is a sample notification from an aged invoice specialist directed to a buyer associated with the aged invoice in an exemplary embodiment.

### DESCRIPTION OF THE PREFERRED EMBODIMENT

The centralized procurement system of the invention relates to a system and process for fulfilling client requirements and supporting activities in the procurement field. Operations are re-engineered from an individually managed commodity-based structure in a distributed environment into a single, cohesive cross-commodity system.

Procurement functions for the business enterprise are re-aligned based upon processes supported (e.g., sourcing, customer/client facing, operations). Tasks historically performed by all parties are reassigned to teams based upon the type of work involved, enabling the centralized procurement system to focus on the administrative activities. The centralized procurement system also enables the business enterprise to leverage resources and enhance processes and tools for driving efficiency and performance improvements inherently lacking in a distributed environment.

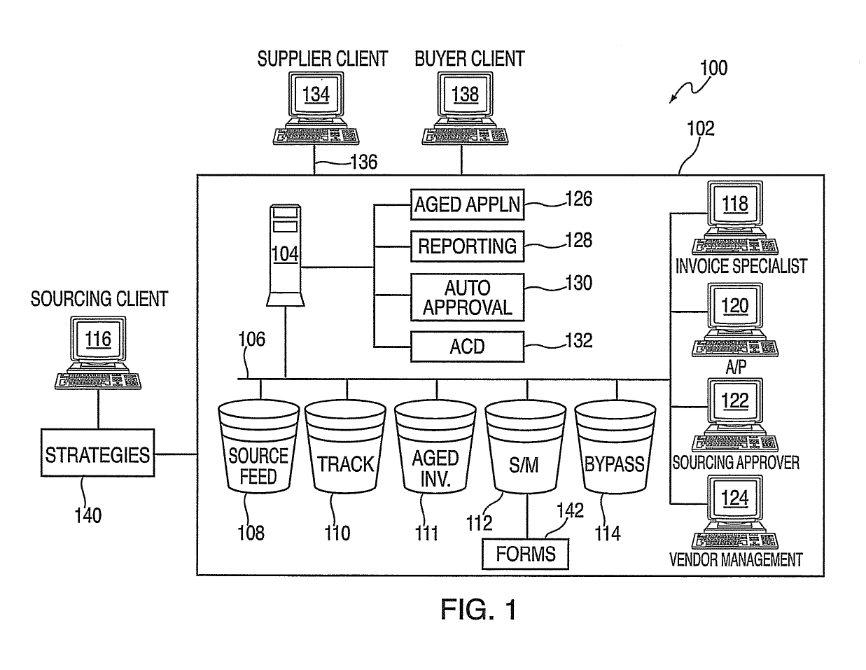

In an exemplary embodiment, the centralized procurement system 102 is implemented via a networked system such as that depicted in FIG. 1. System 100 may be part of a wide area network including multiple geographical locations that are interconnected by high-speed data lines or radio links. In the simplified diagram of FIG. 1, system 100 represents a centralized procurement and sourcing system for a business enterprise. The centralized procurement system 102 of system 100 operates in a client/server architecture mode via a server 104, a network 106, databases 108-114, and client systems 118-124.

Server 104 is associated with databases 108-114 and allows client systems 118-124 to access information stored therein. Client systems 118-124 represent computer workstations operated by representatives of the business enterprise. These representatives include invoice specialists, account payable personnel, a sourcing approval representative, and vendor management personnel and are described further herein.

It should be noted that any number of client systems may be utilized by the centralized procurement system 102. For purposes of illustration, only four client systems 118-124 are shown. Each of client systems 118-124 may comprise a web-enabled personal computing device such as a desktop, laptop, or other similar apparatus known in the art. The term “business enterprise” refers to the organization implementing the centralized procurement system 102 of the invention.

Network 106 may comprise a LAN, a WAN, or other network configuration known in the art. Network 106 may include wireless technology, radio-based communications, telephony-based communications, or a combination of the above. For purposes of illustration, however, network 106 is a LAN Intranet. Access is limited to internal devices and applications through a firewall or similar security system (not shown) which protects system 100 from unauthorized access. The business enterprise preferably executes suitable multi-platform supported server software for creating secure, interactive Internet, Intranet, and Extranet applications, and which allows information stored in server 104 to be managed and presented to end users such as client systems 116, 118-124, 134 and 138 via business applications utilizing data management components (e.g., IBM's DB2™) as well as a presentation component (e.g., Lotus Domino™). System 100 executes the centralized procurement system 102, among other applications via server 104, client systems 118-124, or a combination of the above. Server 104 allows the business enterprise to maintain up-to-date information about procurement activities as well as the efficacy of the tool in a real-time environment through its replication features and web browsers. Server 104 shares information with client systems 118-124, storing the most current data for access by user systems.

Client systems 116, 118-124, 134, and 138 may access server 104 via collaboration, application/data sharing, or standard web browsers (e.g. Lotus Notes™-compliant software, HTML based or Java enabled web applications, etc.) located on these client systems. Software may be Lotus Notes™ although it is not necessary in order to realize the advantages of the present invention.

Internal data storage of server 104 may comprise any form of mass storage device configured to read and write database type data maintained in a file store (e.g., a magnetic disk data storage device) and is logically addressable as a consolidated data source across a distributed environment such as system 100. The implementation of local and wide-area database management systems to achieve the functionality of the storage element will be readily understood by those skilled in the art.

Sourcing feed database 108 is an online repository for allowing commodity personnel to communicate their sourcing strategies. Database 108 stores strategies and guidelines for assisting procurement in exhausting specific supply sources for goods provided in requisitions. These supply sources have been determined by the business enterprise, and particularly the commodity personnel, to be preferred sources of procurement. Requisition items are mapped to sourcing feedback database 108 to evaluate whether a requisition can be viably executed utilizing these core suppliers specified in the sourcing strategies. A requisition comports with a sourcing strategy if the data provided in the requisition refers to items and suppliers approved by commodity personnel.

Tracking database 110 (also referred to as requisition tracker database 110) takes over when a requisition cannot be executed according to a sourcing strategy as noted above. A sourcing buyer is contacted in this situation for resolving the requisition conflict via tracking database 110.

Aged invoice database 111 stores blocked invoices until they are resolved. Database 111 facilitates communication between buyers and accounts payable representatives. A blocked invoice results from a blocked invoice referral upon determining that an invoice received does not match the terms provided in the associated purchase order.

Supplier management database 112 manages information regarding existing and new supplier data such as address, contact information, payment terms, segmentation coding, unblock/block statuses. Database 112 provides the procurement community with an online form 142 to initiate requests to add a new supplier to the supplier base or modify supplier information. The suppler management database 112 provides functionality for automated approval routing (e.g., before a new supplier is added to the supply base, the designated sourcing approver must agree with the action). Within the procurement system, a small subset of individuals monitors these requests and completes any administrative work associated with them. The supplier management database 112 provides a significant level of control and measurement reporting capabilities.

Individuals affected by online forms 142 such as a vendor management group, can incorporate this feature to facilitate the completion of the tasks. This provides additional control, automated approval routing capabilities, increased speed and efficiency, reduction of duplicate tasks. This feature enables enhanced reporting capabilities in the form of visibility to volumes, types of requests, and justifications (e.g., how many new suppliers are added, by whom, reasons, etc.).

Bypass database 114 is fed with bypass occurrences within procurement functions. A bypass occurs when a non-procurement individual makes commitments to a supplier without engaging procurement. Records are downloaded to the centralized procurement system on a predefined basis allowing it to perform the bypass process via an automated approach. The centralized procurement system tracks bypass occurrences by client and organization across all families. This feature allows for a cross-commodity view of occurrences. Bypass database 114 allows procurement to measure infractions across all families and identify multiple offenders more readily. This allows for improved measurements, reporting, and reduced workload via consolidation and automation.

Aged invoice application 126 is a tool that allows procurement to measure blocked invoice volumes against the total amount of invoice activity. The aged invoice application 126 provides invoice specialists with a current list of blocked invoice referrals on a periodic basis. These aged invoice specialists are charged with resolving the conflict that caused the invoice to get blocked.

Reporting application 128 enables the supplier management database to provide visibility to volumes, types of requests, and justifications (e.g., how many new suppliers were added, by whom, reasons for adding, etc.) to procurement. Additionally, reporting application 128 also enables the bypass database 118 to provide measurements of infractions occurring across all families (e.g., identifying multiple offenders more readily).

Auto approval application 130, with the assistance of online forms 142 and supplier management database 112, provide automated approval routing of requests to add or modify suppliers to the supplier base.

Automated call distribution feature 132 provides a single point of contact for the client and supplier base which is used by the tool to manage and distribute calls as needed. Callers are presented with a front-end menu to select from and based on the call type will be routed to the next available customer assistance contact. This feature allows the procurement system to measure call types and performance.

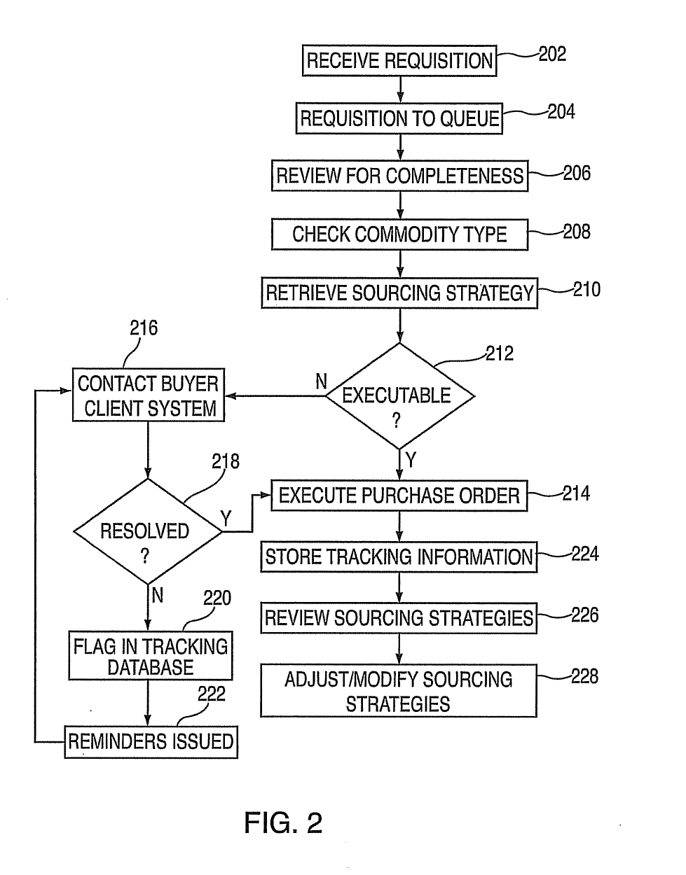

A framework for the flow of information associated with the implementation of the tool is described in FIG. 2. A requisition from buyer client system 138 is received by the centralized procurement system 102 at step 202. The requisition is sent to a queue at server 104 awaiting service at step 204. At step 206, centralized procurement system 102 reviews the requisition for completeness. The commodity type is verified in the requisition at step 208. Based upon the commodity noted, the centralized procurement system 102 retrieves the appropriate sourcing strategies from sourcing feedback database 108. The purpose of this step is to determine if the requisition can be executed against the established strategy provided for a particular commodity. These strategies are all saved in sourcing feedback database 108 and are maintained and updated by sourcing team members at client system 116 via Intranet 106. If the requisition can be fulfilled against an existing sourcing strategy at step 212, the centralized procurement system 102 will complete the purchase order process at step 214 where the purchase order is executed in accordance with the strategies adopted for the relevant commodity. If the requisition cannot be executed against an existing sourcing strategy, the centralized procurement system 102 will solicit the assistance of the appropriate buyer representative at client system 138 to resolve the matter at step 216. For example, one reason that a requisition cannot be executed against a sourcing strategy is where the requisition items to be procured include a part or component that has been found to be deficient in performance or endurance. As a result, the commodity personnel assigned to the particular item has indicated that this part be purchased in limited quantities or under limited circumstances, such as, in the case where no alternative sources of this part are feasible. At step 218 it is determined whether the matter has been resolved with the buyer representative. If so, the process returns to step 216 whereby the purchase order is executed. Simultaneously, the information is stored in tracking database 110 at step 220.

If on the other hand, the issue could not be resolved, the centralized procurement system 102 stores the information in tracking database 110 and reminders are periodically sent to a sourcing representative at client system 116 for additional information and resolution at step 222. Sourcing team members periodically review and identify potential issues that caused the conflict at step 224 and modify sourcing strategies if necessary at step 226.

By standardizing and process specialization, fewer resources are required to support these procurement tasks resulting in lower operational costs for the business enterprise. Since the tool provides a significant level of control over the purchase order placement process, the sourcing teams have immediately visibility to client needs previously lacking in prior art systems. The continuous feedback provided by the tool provides the sourcing teams with the information needed to continuously improve and revise their sourcing strategies to make them more effective and executable at a transactional level.

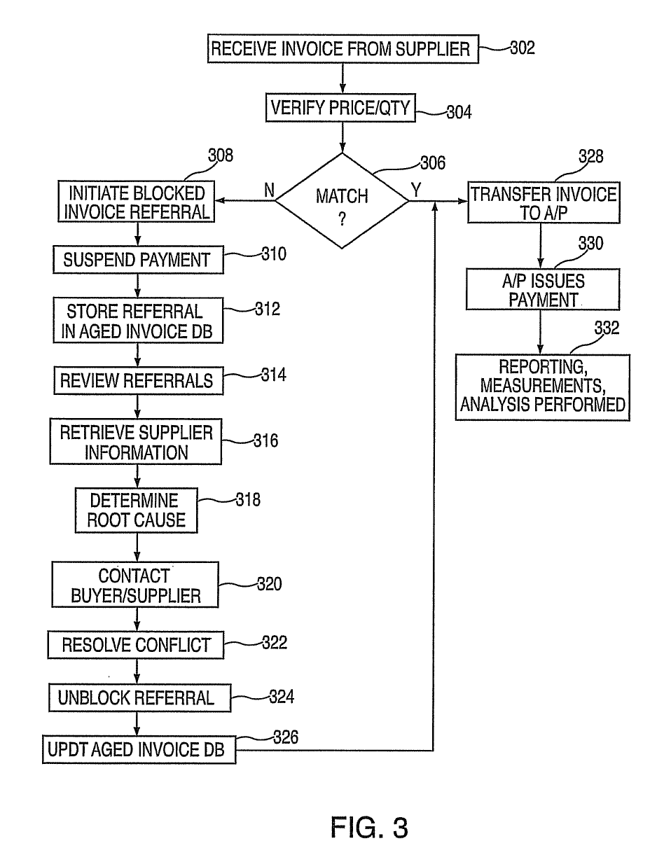

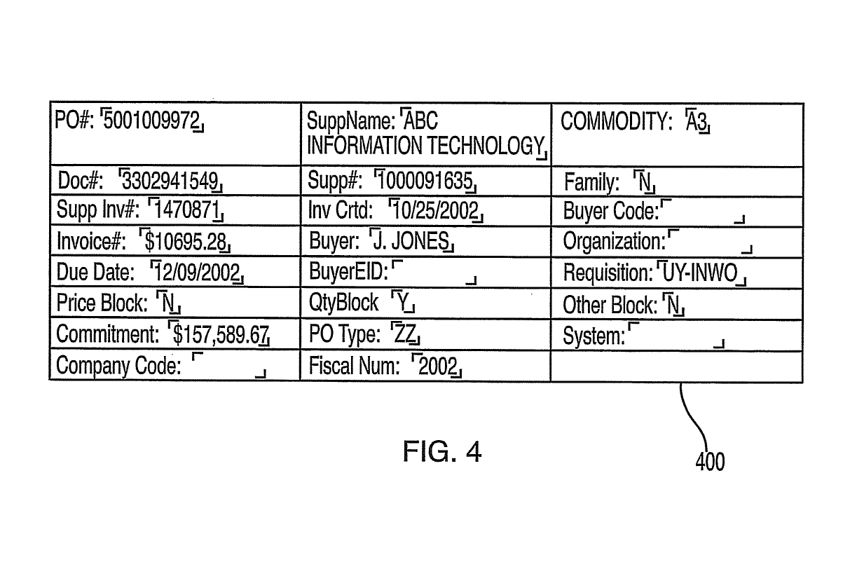

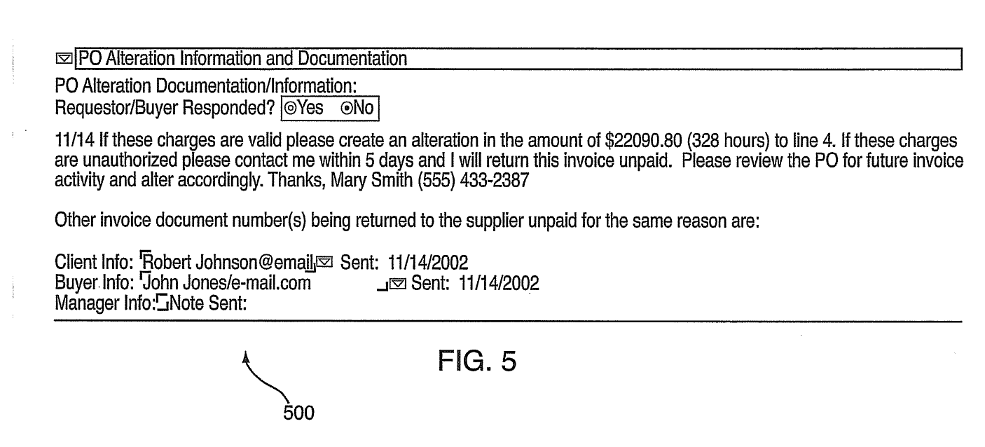

FIG. 3 illustrates the “blocked invoice” process implemented via the centralized procurement system 102. A supplier at client system 134 submits an invoice to the centralized procurement system 102 at step 302. The centralized procurement system 102 checks to see if the price and/or quantity terms stated in the invoice match those recited in the purchase order at step 304. At step 306, a determination is made whether the invoice sufficiently matches the purchase order. If not, the centralized procurement system 102 initiates a blocked invoice referral via aged invoice application 126 at step 308. This causes any payments to this supplier to be suspended at step 310. All blocked invoice referrals are stored in aged invoice database 111 at step 312. The invoice specialist at client system 118 receives the blocked invoice referral at step 314 and reviews it. The invoice specialist then retrieves relevant supplier information from aged invoice database 111 necessary to resolve the matter at step 316. FIG. 4 illustrates a sample computer screen displaying an invoice document 400 as seen by an invoice specialist. Document 400 provides a variety of information relating to the purchase order and the supplier, as well as the buyer information. At step 318, the invoice specialist determines the root cause of the conflict. The invoice specialist then contacts the supplier and/or buyer at step 320 to notify them of the root cause of the conflict. Among these parties, the matter is resolved at step 322. A sample computer screen and resolution message 500 is illustrated in FIG. 5. The invoice is unblocked by the invoice specialist at step 324 and the aged invoice database 111 is updated at step 326. The invoice is transferred to an accounts payable representative at client system 120 at step 328. At step 330, the accounts payable representative issues payment for the invoice. This information can be organized so that measurements, reporting and analysis can be performed on the data via reporting application 128 at step 332.

The blocked invoice process provides a common approach and communication method where affected parties can receive a significant level of detail to aid with the resolution of the conflict as well as streamlining the points of contact within procurement that they need to deal with. This process enables the business enterprise to capture root causes and is readily available by supplier, family, client, reason code, etc. to allow procurement the ability to drive down the overall volumes of blocked invoices occurring on a monthly basis. This process further allows for improved measurements. The aged invoice application 126 permits procurement to measure the total volume of blocked invoice referrals against the total invoices processed while incorporating the actual payment terms of the purchase orders.

As can be seen, the centralized procurement system re-aligns procurement functions for a business enterprise based upon processes supported enabling the centralized procurement system to focus on the administrative activities. The centralized procurement system also enables the business enterprise to leverage resources and enhance processes and tools for driving efficiency and performance improvements inherently lacking in a distributed environment.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method for facilitating procurement functions over a computer network, comprising:
receiving an invoice at a centralized procurement location;
retrieving a purchase order associated with the invoice;
comparing price terms on the invoice to price terms on the purchase order;
comparing quantity terms on the invoice to quantity terms on the purchase order;
if the price terms on the invoice and the quantity terms on the invoice match the price terms on the purchase order and the quantity terms on the purchase order, transferring the invoice to an accounts payable representative for payment; and
if either of the price terms on the invoice and the quantity terms on the invoice does not match either of the price terms on the purchase order and the quantity terms on the purchase order, initiating a blocked invoice referral.

2. The method of claim 1, further comprising:
suspending payment to a supplier associated with the blocked invoice referral;
transmitting the blocked invoice referral to an invoice specialist;
determining a root cause of the blocked invoice referral;
utilizing the root cause information, resolving conflict that caused the blocked invoice referral; and
unblocking the blocked invoice referral operable for causing payment to be issued.

3. A storage medium for facilitating procurement functions over a computer network, the storage medium embodied with computer-readable instructions, which when executed cause a computer to implement a method, comprising:
receiving an invoice at a centralized procurement location;
retrieving a purchase order associated with the invoice;
comparing price terms on the invoice to price terms on the purchase order;
comparing quantity terms on the invoice to quantity terms on the purchase order;
if the price terms on the invoice and the quantity terms on the invoice match the price terms on the purchase order and the quantity terms on the purchase order, transferring the invoice to an accounts payable representative for payment; and
if either of the price terms on the invoice and the quantity terms on the invoice does not match either of the price terms on the purchase order and the quantity terms on the purchase order, initiating a blocked invoice referral.

4. The storage medium of claim 3, further comprising instructions for causing the computer to implement:
suspending payment to a supplier associated with the blocked invoice referral;
transmitting the blocked invoice referral to an invoice specialist;
determining a root cause of the blocked invoice referral;
utilizing the root cause information, resolving conflict that caused the blocked invoice referral; and
unblocking the blocked invoice referral operable for causing payment to be issued.
